(19) United States
(12) Patent Application Publication
(10) Pub. No.: US 2009/0070731 A1
(43) Pub. Date: Mar. 12, 2009

(54) Distributed Mask Data Preparation

(75) Inventor: Weidong Zhang, San Jose, CA (US)

Correspondence Address: MENTOR GRAPHICS CORP.;PATENT GROUP, 8005 SW BOECKMAN ROAD, WILSONVILLE, OR, 97070-7777, US

(73) Assignee: Mentor Graphics Corporation, Wilsonville, OR (US)

(21) Appl. No.: 11/851,342

(22) Filed: Sep. 6, 2007

(51) Int. Cl. G06F 17/50

(52) U.S. Cl. 716/19

(57) ABSTRACT

Layout data is divided into segments of data, and each segment of data is distributed to a computing node in a parallel processing fracturing tool. During the fracturing process, the fracturing tool generates one or more global parameter values for each segment of data. After the fracturing process is completed, the fracturing tool will merge the segments back together using the global parameter values to ensure that the merger of the data segments does not exceed a constraint of the reticle or mask writer in which the fractured data will be employed.

### FIELD OF THE INVENTION

The present invention is directed to the division of data for distribution to separate processes, and the subsequent merging of the processed data into larger unit. Various aspects of the invention may be particularly useful in distributing layout data for a circuit design among multiple processors for fracturing, and then merging the subsequently fractured data together for use by a mask writer.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires will be formed to connect the circuit devices. Typically, a designer will perform a number of analyses on the layout design. For example, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

After the layout design has been finalized, it is converted into a format that can be employed by a mask or reticle writing tool to create a mask or reticle for use in a photolithographic manufacturing process. Masks and reticles typically are made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not right triangles, rectangles or trapezoids (which typically is a majority of the geometric elements in a layout design) must be “fractured” into the smaller, more basic polygons that can be written by the mask or reticle writing tool. This process sometimes is referred to as “mask data preparation.”

Once a layout design has been fractured into shots, then the fractured layout design data can be converted to a format compatible with the mask or reticle writing tool. Examples of such formats are MEBES, for raster scanning machines manufactured by ETEC, an Applied Materials Company, and various vector scan formats for Nuflare, JEOL, and Hitachi machines, such as VSB11 or VSB12. The written masks or reticles then can be used in a photolithographic process to expose selected areas of a wafer to light or other radiation in order to produce the desired integrated circuit devices on the wafer.

Layout designs can be very large. For example, one layout data file for a single layer of a field programmable gate array may be approximately 58 gigabytes. Accordingly, the process of fracturing a layout design is extremely expensive, both in terms of computing resources and processing time. To address these problems, some fracturing tools employ parallel processing techniques to reduce both the fracturing time and computing load on an individual processor. While these parallel processing techniques are an improvement over conventional fracturing techniques, they still have some limitations.

For example, it is difficult to divide up layout data so as to make the fracturing process scalable to a particular parallel processing environment. Conventional mask writers will scan across a mask or reticle from one side to the opposite side in a linear fashion. Correspondingly, the converted layout data must be provided to the mask writer in a linear fashion. If a layout design is divided into “frames” of data extending in a line from one end of the circuit design to the opposite end of the circuit design, however, each frame can still contain a relatively large amount of data. As a result, each computing node in the parallel processing system must have a relatively large memory to fracture a frame of layout data. Further, if the number of frames is smaller than the number of computing nodes in the system, then the extra nodes will sit idle.

### BRIEF SUMMARY OF THE INVENTION

Aspects of the invention relate to techniques for more efficiently distributing data among computing nodes in a parallel processing system. Various aspects of the invention also relate to techniques for merging processed data into larger data blocks for further processing. As will be discussed in detail below, implementations of both tools and methods implementing these techniques have particular application for fracturing layout design data, such as integrated circuit design data.

According to various implementations of the invention, layout data is divided into segments (sometimes referred to herein as “sub-frames”), and each segment of data is distributed to a computing node in a parallel processing fracturing tool. During the fracturing process, the fracturing tool generates global parameter values for each segment of data. After the fracturing process is completed, the fracturing tool will merge the segments back together using the global parameter values. With some implementations of the invention, for example, a single computing node will examine the values of global parameters for each data segment in a group of data segments, cumulatively summing the values for each global parameter. If the cumulative sum of the values of a global parameter exceeds a corresponding data block constraint value, then the data segments in the group will not be merged back into a single data block. Instead, the information in the data segments will be merged into two or more separate data blocks. This merging process then is repeated for each group of data segments in the layout design.

During the merging process, the computing node obtains a portion of the layout data in the data segment. More particularly, the computing node saves this portion (sometimes referred to herein as a “cell”) in local memory. The computing node will then determine into which data blocks the portion should be merged, and saves a copy of the portion at a memory location associated with each of those data blocks. Referring back to the data segment, the computing node also will determine the placements of the portion for each data block into which the portion will be merged. It will then save the placements at the memory location associated with each of those data blocks as well. Because the computing node handles only one portion of a data segment at a time, it will use a substantially smaller amount of local memory than might otherwise be required to handle an entire group of layout design data segments. Additionally, because it processes each portion sequentially, the computing node can replace a previously-processed portion saved in local memory with the portion currently being processed, thereby conserving its local memory resources.

These and other features and aspects of the invention will be apparent upon consideration of the following detailed description.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates a layout data fracturing tool that may be implemented according to various examples of the invention.

FIGS. 4A and 4B illustrate a flowchart showing a method of dividing and fracturing a layout design that may be employed by various embodiments of the invention.

FIGS. 5A and 5B illustrate the division of a layout design into frames.

FIG. 6 illustrates a division of a layout design into sub-frames that may be implemented according to various embodiments of the invention.

FIG. 7 illustrates a division of a sub-frame of layout design data that may be implemented according to various embodiments of the invention.

FIG. 8 schematically illustrates the division and fracturing of a layout design according to various embodiments of the invention.

FIGS. 9-11C illustrate flowcharts showing a method of merging fractured layout design data that may be employed by various embodiments of the invention.

FIG. 12 illustrates an organization of a fractured layout design that may be provided according to various embodiments of the invention.

### DETAILED DESCRIPTION OF THE INVENTION

### Exemplary Operating Environment

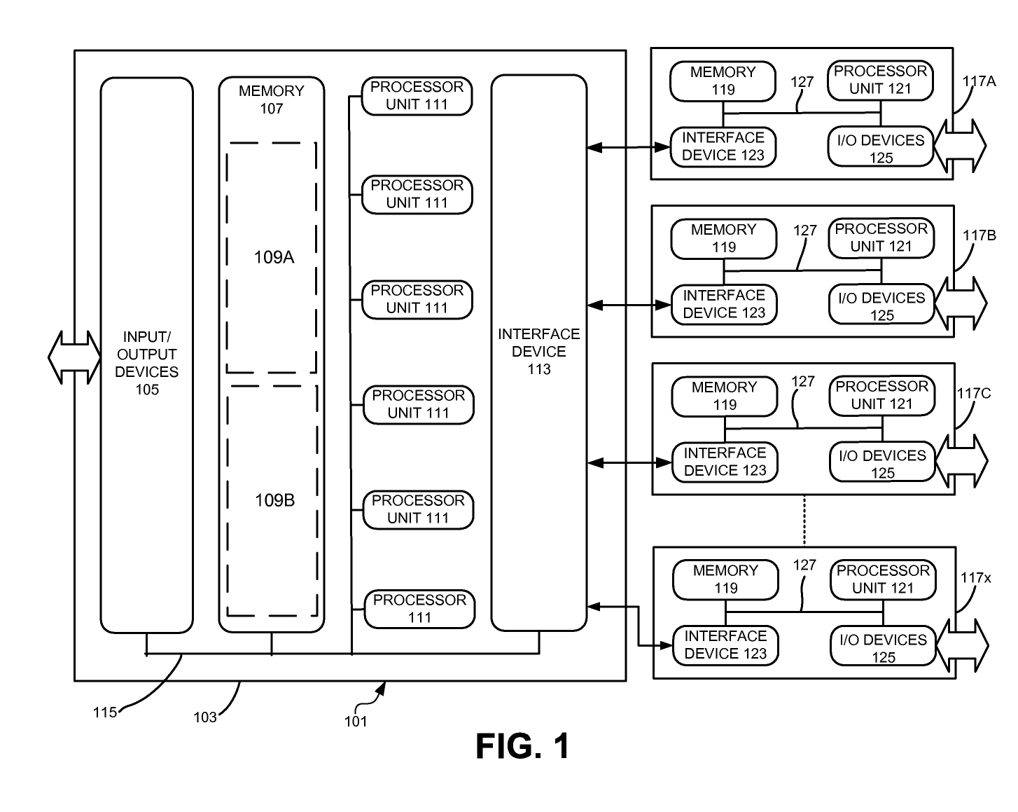

The execution of various electronic design automation processes may be implemented using computer-executable software instructions executed by one or more programmable computing devices. Because these examples of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium®) or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

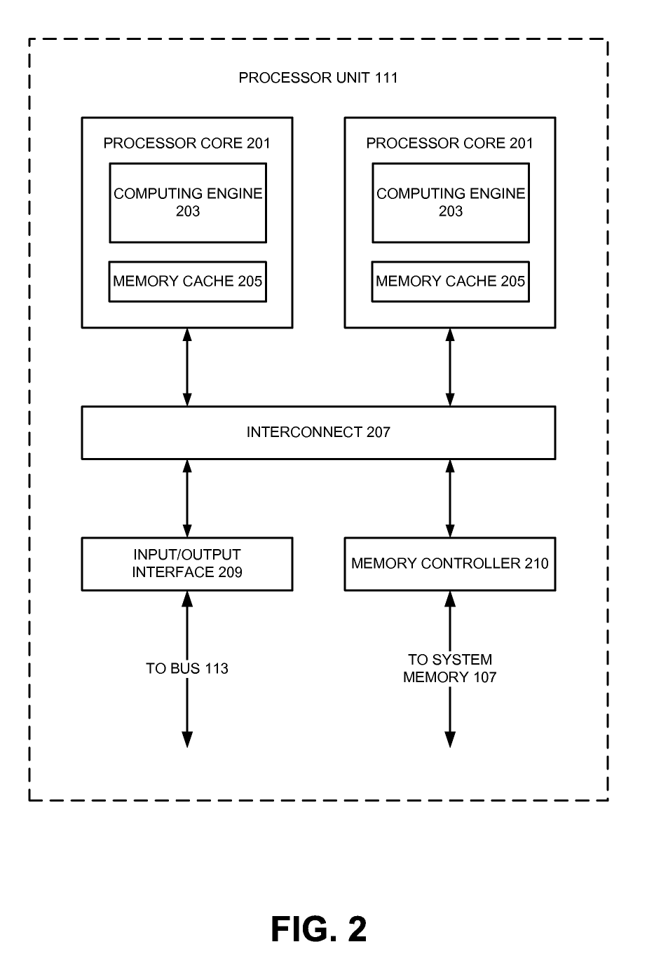

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may alternately or additionally have multiple processor units 121, depending upon their intended use, as previously discussed. Also, while only a single interface device 113 or 123 is illustrated for both the master computer 103 and the servant computers 117, it should be noted that, with alternate embodiments of the invention, either the master computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and is not intended to suggest any limitation as to the scope of use or functionality of alternate embodiments of the invention.

### Layout Data Fracturing Tool

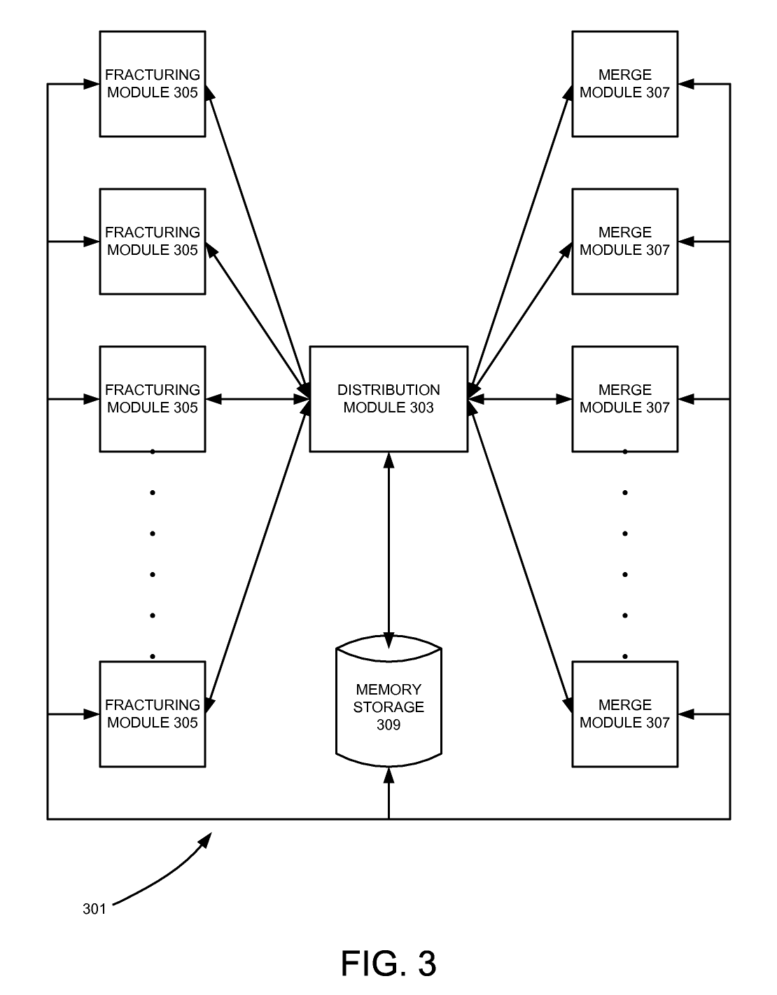

FIG. 3 illustrates an example of a layout data fracturing tool 301 that may be implemented according to various examples of the invention. As seen in this figure, the tool 301 includes a distribution module 303 and a plurality of fracturing modules 305. The fracturing tool 301 also includes a plurality of merge modules 307 and a memory storage 309. As previously noted, various examples of the invention may be implemented by a parallel processing computing system, such as the parallel processing computing system 101 illustrated in FIG. 1. Accordingly, the distribution module 303 may be implemented using one or more processors in a multiprocessor computing system's master computer, such as the master computer 103. Similarly, each of the fracturing modules 305 and each of the merge modules 307 may be implemented using one or more servant computers in a parallel processing computing system, such as the servant computers 117. Of course, one or more of the fracturing modules 305 or the merge modules 307 may alternately or additionally be implemented using available processors in a parallel processing computing system's master computer if it employs more than one processor. It also should be appreciated that, while the fracturing modules 305 and the merge modules 307 are shown as separate units in FIG. 3, a single servant computer (or a single processor within a multiprocessor master computer) may be used to implement both a fracturing module 305 and a merge module 307 at different times.

The memory storage 309 may be any data storage device that is accessible to each of the fracturing modules 305 and the merge modules 307. For example, the memory storage 309 may be a magnetic disk drive, a rewritable optical disk drive, etc. As will be appreciated from the discussion that follows, the memory storage 309 typically will be relatively large, so as to be able to simultaneously store both an original layout design and a fractured version of the original layout design. Accordingly, with various examples of the invention, the memory storage 309 will be a conventional magnetic disk drive that is capable of inexpensively storing and reading relatively large amounts of data. Of course, while a single memory storage 309 device is illustrated in FIG. 3, alternate examples of the invention may employ two or more separate memory storage devices working in concert to implement the memory storage 309.

In addition to the memory store 309, each of the distribution module 303, the fracturing modules 305 and the merge modules 307 will have (or have access to) some type of local memory. As will be appreciated by those of ordinary skill in the art, the local memory typically will be implemented by some type of solid state memory device that is accessible at speeds comparable to the operation speed of the processor or processors being used to implement the corresponding distribution module 303, fracturing module 305, or merge module 307. For example, the local memory may be implemented with a memory cache integrally formed with the processor, a solid state memory device formed on a separate integrated device from the processor (e.g., a synchronous dynamic random access memory device), or some combination thereof.

### Fracturing Layout Data

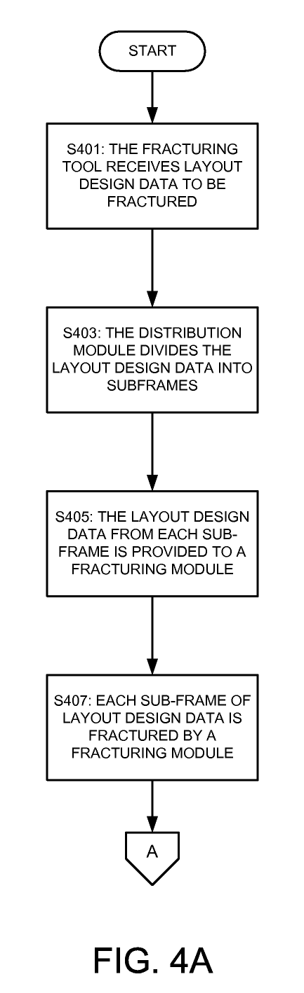

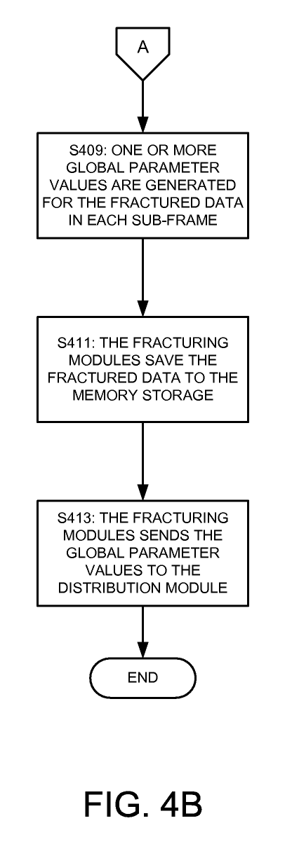

The operation of the fracturing tool 301 for fracturing layout design data will now be discussed with reference to the flowchart illustrated in FIGS. 4A and 4B. Initially, in step 401, the fracturing tool 301 receives layout design data to be fractured. With some implementations of the invention, the fracturing tool 301 may receive the layout design data from a hierarchical database used to physically verify the layout design data prior to fracturing. Alternately, the layout design data may be retrieved from a data server, or stored directly into the memory storage 309 for use by the fracturing tool 301. As used herein, the term “design” is intended to encompass both the design of an entire microdevice, such as an integrated circuit, and portions of a design of an entire microdevice. For example, the term layout design, as used herein, may apply to the design data for only a single layer of a microdevice, or even a section of a single layer of a microdevice. The layout design may be in any conventional layout design data format, such as OASIS or GDSII.

Most mask writers are either raster-scanning or vector-scanning. With raster-scanning mask writers, the writing beam traverses the mask substrate from one side to the opposite side in a straight line, while the mask substrate typically is moved orthogonal to the movement direction of the beam. The writer then interrupts the beam for those areas (e.g., pixels) where an image should not be formed. Alternately, the mask writer may use some type of gray-scaling technique to generate the desired image without interrupting the beam. With vector scanning, the writer moves the beam to only those areas of the mask substrate where a portion of the desired image should be written. The mask writer will then either scan the area of the image portion with beam using, e.g., a raster pattern, or vary the shape of the beam to write the image portion. With both raster scanning mask writers and vector scanning mask writers, however, the beam typically will traverse the mask in a linear fashion from one end of mask substrate to the opposite end of the mask substrate.

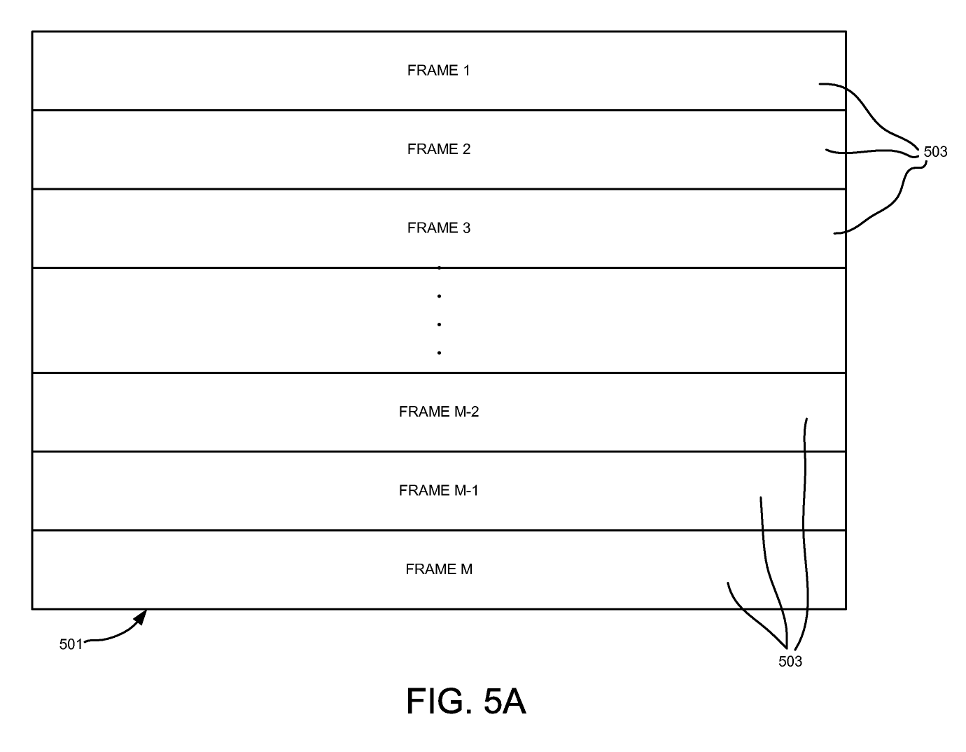

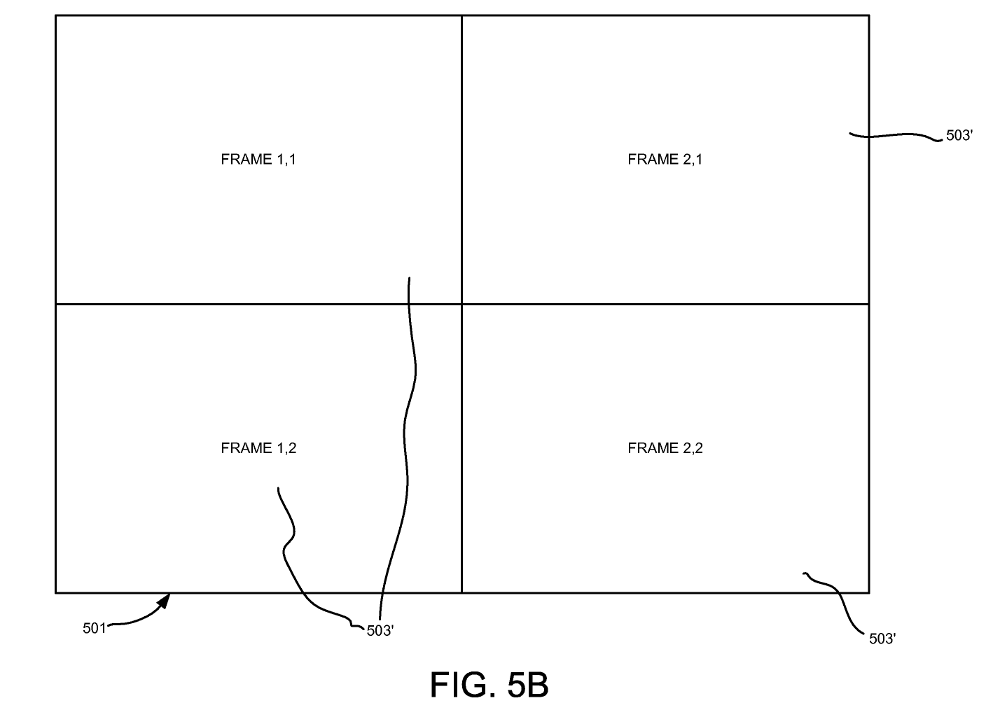

Accordingly, the mask writing data must be delivered to the writer in such a way that it matches the linear operation of the beam. Conventionally, a layout design is divided into frames for submission to a mask or reticle writer. For example, as shown in FIG. 5, a layout design 501 may be divided into M number of frames 503. The height of each frame 503 will typically correspond to one or more aspects of the mask writer that will use the data. For example, each frame may have a height that is a multiple of some integral divisor of the mask writer's maximum writing height. If the maximum writing height of the mask writer is 2000 microns, then the frames 503 may have a height of 250 microns, 500 microns, 1000 microns or 2000 microns.

While a frame's height may be, e.g., 2000 microns, 1000 microns, 500 microns, or 250 microns, the width of the frame typically will still span the entire length of the layout design. For current leading-edge designs with dense geometries, the memory needed for processing and fracturing a whole frame may easily exceed the maximum amount of local memory (e.g., 2 GB) typically available to a servant computing node in a conventional parallel processing computing system. Moreover, the geometry density of layout designs will only continue to increase for new technologies. Various examples of the invention may therefore divide a layout design into segments that are smaller than conventional frames, and thus may be more easily processed using the local memory resources typically available to servant computing nodes in conventional parallel processing computing system.

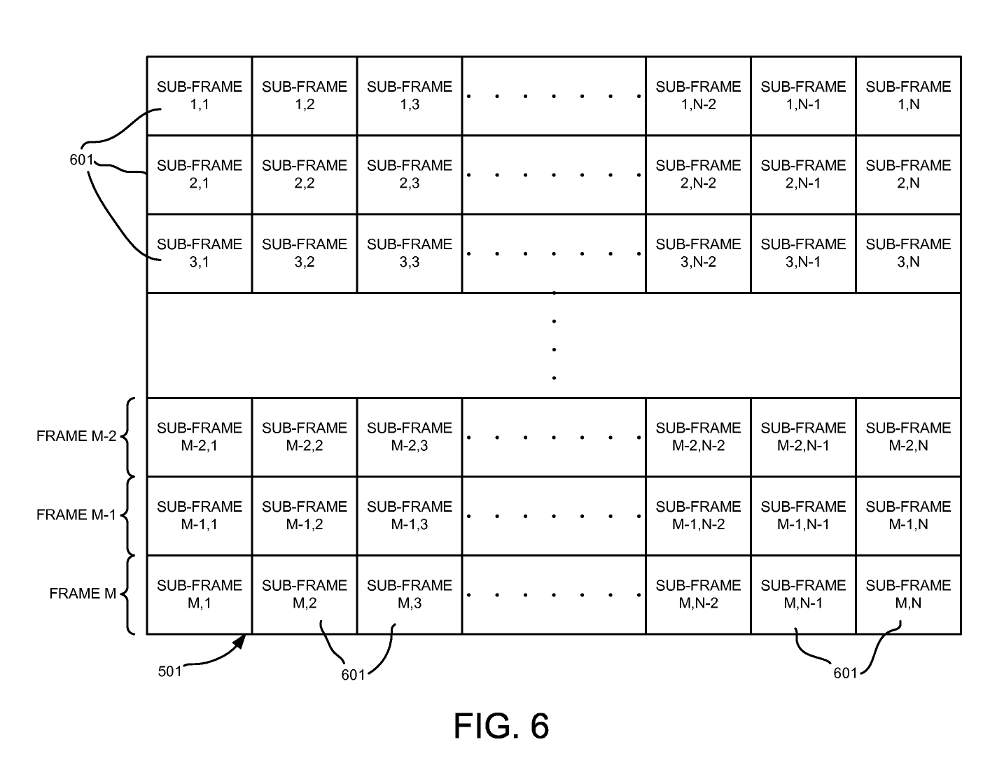

More particularly, in step 403, the distribution module 303 divides the layout design 501 into smaller segments or “sub-frames.” For example, instead of dividing the layout design 501 into frames 1 to M, the distribution module 303 may divide the layout design 501 into sub-frames 601, such as sub-frame 1,1, to sub-frame M,N, shown in FIG. 6. As will be appreciated by those of ordinary skill in the art, dividing the layout design 501 into the finer sub-frames will provide better scalability for a parallel computing system having a large number of servant computers (e.g., more than 100 servant computers) than dividing the layout design into the larger, more coarse conventional frames.

With various embodiments of the invention, the height of the sub-frames, the width of the sub-frames, or both may be adjustable as desired. In some implementations, for example, a user may select the height of a sub-frame to correspond with the physical requirements of the mask writer that will employ the fractured data. As previously noted, some reticle or mask writers could have a maximum writing height of 2000 microns. For these writers, a user may thus select the height of the sub-frames 601 to be 250 microns, 500 microns, 1000 microns or 2000 microns.

Similarly, a user may select the width of the sub-frames to correspond with the physical requirements of the mask writer that will employ the fractured data. Having a user-controllable sub-frame width allows a user to alternately choose a sub-frame width that will better correspond to the resources available to the fracturing modules. For example, if the fracturing modules 305 are implemented by conventional, off-the-shelf computers acting as servant computing nodes in a parallel processing system, then each fracturing module 305 may have less than 2 GB of local memory available for use. Accordingly, the width of the sub-frames can be selected so that each sub-frame will contain less than 2 GB of layout design data. For a layout design with about 300 GB of data, for example, a user could select the sub-frame width so that the design is divided into approximately 2000-3000 sub-frames. The total amount of data from each frame would then be approximately 100-150 MB. Of course, still other techniques can be used to divide the frames 501 into sub-frames. For example, the size of each sub-frame may be set to correspond to the number of available servant computers.

The layout design data from each sub-frame is provided to a fracturing module 305 in step 405. For example, the data for sub-frame 1,1 may be provided to one fracturing module 305, while the data for sub-frame 1,2 may be provided to another fracturing module 305. With some implementations of the invention, the distribution module 303 may assign a fracturing module 305 a specific sub-frame to fracture. The fracturing module 305 then can retrieve the layout design data in this sub-frame from the memory storage 309 or other data source. For example, various implementations may distribute layout design data to the fracturing modules 305 directly through the distribution module 303. With these implementations, each fracturing module 305 may obtain its portion of the layout design data from, e.g., the local memory for the distribution module 303. With still other embodiments of the invention, however, each fracturing module 305 may obtain layout design data itself at the instruction of the distribution module 303. For example, in some implementations of the invention, the distribution module 303 may assign a particular sub-frame to a fracturing module 305 for fracturing. The fracturing module 305 may then retrieve the layout design data in the assigned sub-frame directly from the memory storage 309, a remote data server, or other data source. This arrangement may be particularly useful with a relatively large layout design data file.

In step 407, each sub-frame of layout design data is fractured by a fracturing module 305. As well known in the art, layout design data typically must be converted into a format that can be employed by a mask or reticle writing tool. Most mask writing tools are able to only write only specific types of geometric elements onto a mask, however, such as right triangles, rectangles or other trapezoids. Moreover, the sizes of the polygons are limited physically by the maximum beam aperture size available to the mask or reticle writing tool. Larger geometric elements in the layout design, as well as geometric elements that do not match the specific types that can be written by the mask or reticle writing tool, must be divided up or “fractured” into the smaller, more basic polygons that can be written by the mask or reticle writing tool.

Thus, fracturing the layout design data in a sub-frame includes dividing each polygon in the sub-frame into a set of triangles, rectangles or other trapezoids that can be processed by the relevant mask writer. It also typically includes converting the data describing each resulting triangle, rectangle or other trapezoid into a data format that can be processed by a desired mask writer. Examples of such formats are MEBES, for raster scanning machines manufactured by ETEC, an Applied Materials Company, and various vector scan formats for Nuflare, JEOL, and Hitachi machines, such as VSB11 or VSB12. It should be appreciated, however, that various embodiments of the invention may output fractured data in its original format (e.g., in the GDSII or OASIS data format) for subsequent conversion into a data format for a particular reticle or mask writer device. Accordingly, as used herein, the term “fractured data” is intended to encompass both fractured data in a layout design format and fractured data that has been converted into a data format compatible with a reticle or mask writer.

In addition to fracturing the layout design data in a sub-frame, the fracturing module 305 will also generate one or more global parameter values for each sub-frame in step 409. As will be discussed in more detail below, each global parameter corresponds to a limitation or other feature associated with the mask or reticle writer that will use the fractured data. For example, a mask or reticle writer typically will have a maximum size for input data files. That is, the mask or reticle will define a maximum amount of fractured data that it can handle for a single mask or reticle writing operation. Accordingly, one of the global parameters generated for each sub-frame will be the total size for the fractured data in that sub-frame.

To speed writing times, some mask writers are accepting data formats that provide for a hierarchical organization of the data into collections of geometric elements, typically referred to as “cells.” For example, some mask writer data formats allow grouping of primitive geometries consisting of triangles, rectangles and certain types of trapezoids into cells, which can be placed one or more times in the fractured data at different geometrical locations. (It should be appreciated that various other equivalent terms may alternately be employed instead of the term “cell,” depending upon the nomenclature used by a particular data format.) Each cell can then be treated as a single element.

With some data formats, a cell may even contain other cells. For example, in a microprocessor or flash memory design, all of the geometric elements making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the layout design data describing other miscellaneous circuitry required for the register, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

While most mask or reticle writers allow for only a limited number of hierarchy levels, the use of a hierarchical data organization can still save considerable memory and improve processing. Instead of requiring a separate description of each placement of a geometrical element to be created on a mask, hierarchical fractured data can include only a single description of the geometrical objects in a cell, together with a location for each placement of the cell in the design. Accordingly, with various examples of the invention, the fracturing module 305 may create one or more cells when fracturing the layout design data in a sub-frame.

With these implementations, the fracturing module 305 may generate a value for one or more global parameters for the sub-frame that are associated with the hierarchical organization of the fractured layout design data. For example, some masks or reticles may have a limit on the number of different cell definitions that may be included in an input data block, a limit on the total number of placements for all cells that may be included in an input data block, or both. The global parameters may then include the number of different cells in the fractured data for the sub-frame, the combined number of placements for all cells that are included in the sub-frame, or both. Of course, other embodiments of the invention may generate alternate or additional global parameters, depending upon the intended use of the data.

With various examples of the invention, a single set of global parameter values is generated for the entire sub-frame. As will be discussed in more detail below, however, once the layout design data in a sub-frame is fractured, it may be necessary to divide that data among two or more data blocks before providing it to a reticle or mask writer. Accordingly, various implementations of the invention may additionally partition each sub-frame into two or more sections, and then determine a set of global parameter values for each section. Some embodiments of the invention may further determine a set of global parameter values for combinations of different sub-frame sections.

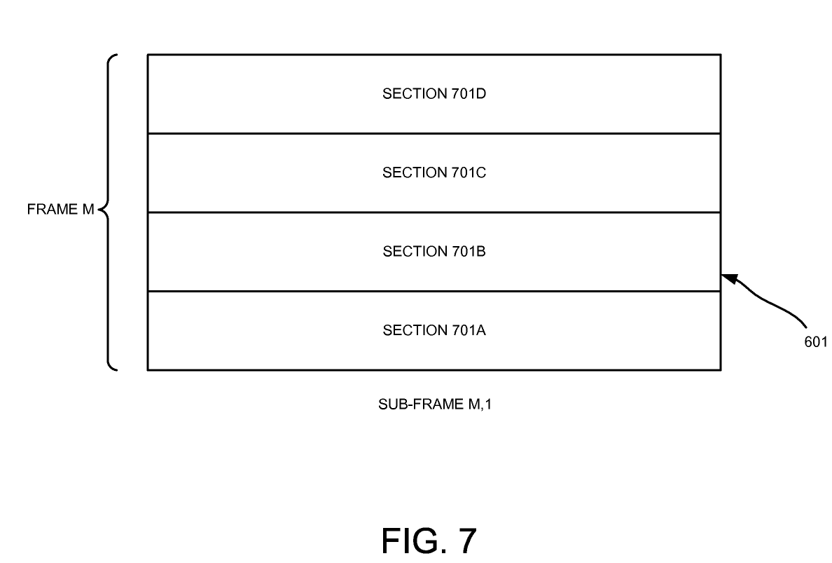

For example, a fracturing module 305 may partition a sub-frame (e.g., sub-frame M,1) into four sections 701A-701D, as illustrated in FIG. 7. The fracturing module 305 will then determine the values of the global parameters for the entire sub-frame (denoted as P{section 701A+section 701B+section 701C+section 701D} herein for convenience), as discussed in detail above. In addition, the fracturing module 305 will also determine the global parameter values for the layout design data in section 701A (i.e., P{section 701A}), the layout design data in section 701B (i.e., P{section 701B}), the layout design data in section 701C (i.e., P{section 701C}), and the layout design data in section 701D (i.e., P{section 701D}). With some implementations of the invention, the fracturing module 305 may additionally determine the global parameter values for the combination of the sections 701A and 701B (i.e., P{section 701A+section 701B} and the global parameter values for the combination of the sections 701C and 701D (i.e., {section 701C+section 701D}. The use of these global parameter values will be discussed in detail below.

In addition to determining global parameters values for each section of a sub-frame, the fracturing module 305 may also record the occurrence of each cell within the sub-frame. For example, the fracturing module 305 may generate a byte of occurrence information for each cell definition, and use the byte of information to indicate if a cell has placements in any of sub-frame sections 701A, 701B, 701C, or 701D. For example, the ith bit (where i=1, 2, 3, 4) may be given a value of “1” to indicate that the cell has a placement in the section 701i, and given a value of “0” to indicate that the cell does not have a placement in the section 701i. This cell occurrence information can be saved to, e.g., a local memory for the distribution module 303, the memory storage 309, or any other desired location that subsequently can be accessed by the merge modules 307 during the merge operation. A conventional frame may have a maximum of 1 million cell definition, requiring approximately 0.5 MB of space to store the associated cell occurrence information. Typically, a row of 10−20 sub-frames will correspond to a single conventional frame, so the amount of memory required to store the cell occurrence information per sub-frame would be approximately 0.025 MB-0.05 MB.

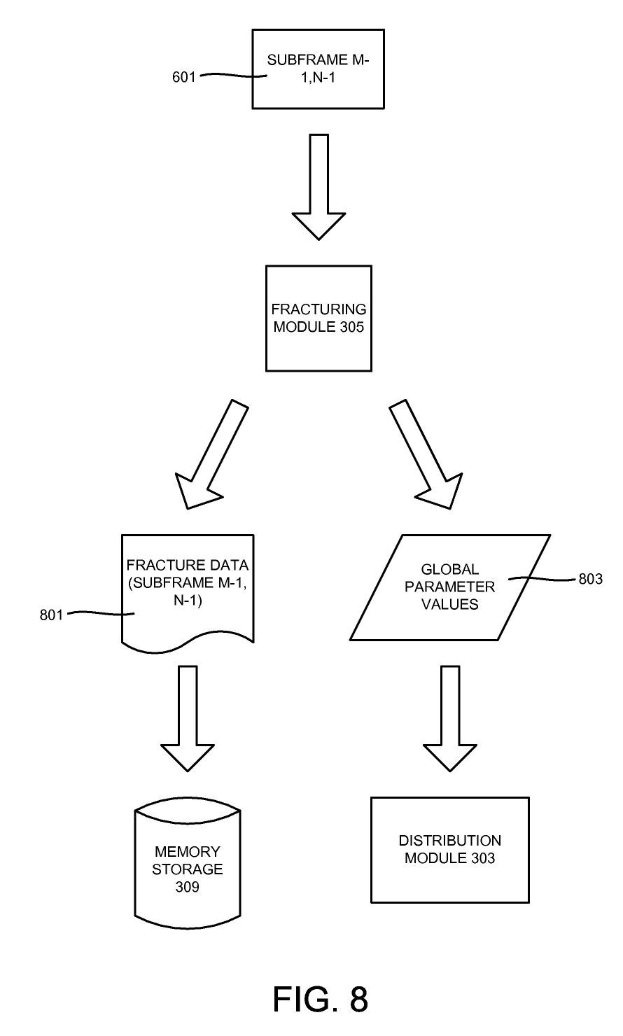

Once the layout design data for a sub-frame 601 has been fractured, in step 411 the fracturing module 305 saves the fractured data 801 in the memory storage 309, as shown in FIG. 8. As previously noted, conventional reticle or mask writers process and write the design data in a linear fashion, starting from one side of the circuit design and ending at the opposite side of the circuit design. Accordingly, various implementations of the invention will organize the sub-frames of layout design data into groups of one or more rows that extend from one side of the circuit design to the opposite side of the circuit design. This organization may allow the layout design data in the sub-frames 601 to be more easily merged into data blocks compatible with conventional reticle or mask writers.

With some implementations of the invention, a group made up of a single row of sub-frames may correspond to a conventional frame. For example, the group of sub-frames M,1 to M,N shown in FIG. 6 may correspond to the conventional frame M illustrated in FIG. 5A. As will be discussed in more detail below, still other implementations of the invention may size the height of the sub-frames 601 so that a group of sub-frames made up of two or more rows of sub-frames 601 will correspond to a conventional frame. The fractured data for each sub-frame 601 in a group corresponding to a frame may then be stored together at a single memory location.

In step 413, the fracturing module 305 sends the generated global parameter values 803 for each sub-frame to the distribution module 303. The distribution module 303 may, for example, store the global parameter values 803 in a table, either in the memory storage 309, in local memory, or at any other desired memory location. As noted above, a group of sub-frames 601 may correspond with a conventional frame. Accordingly, various examples of the invention may store the global parameters values associated with each of the sub-frames 601 in a group corresponding to a single conventional frame together.

### Merging Fractured Data

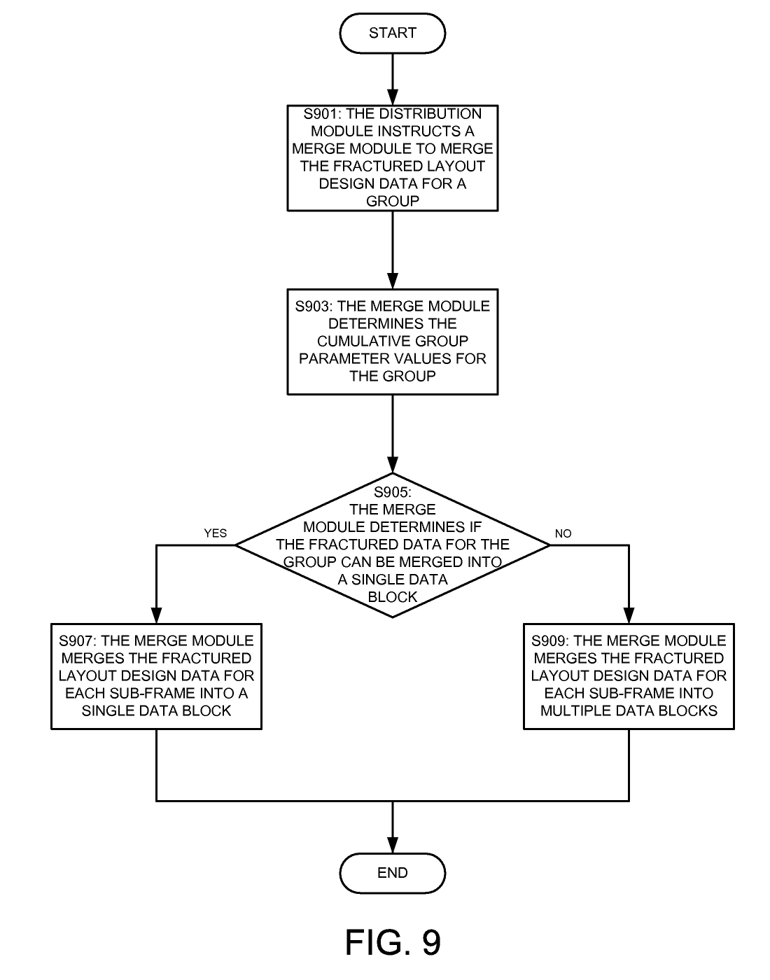

After all of the layout design data for a group has been fractured, the fracturing tool 301 will then merge the fractured data for each sub-frame back together into larger blocks of data that can be provided to the mask or reticle writer. A merging operation of the fracturing tool 301 according to various embodiments of the invention will now be discussed with reference to the flowchart illustrated in FIGS. 9A and 9B.

In step 901, the distribution module 303 instructs a merge module 307 to merge the fractured layout design data for a group of sub-frames 601. As previously noted, a group of sub-frames 601 typically will correspond to a conventional frame 503. More particularly, the distribution module 303 identifies an available merge module 307, and provides it with a reference to the group and the location or locations in the memory storage 309 where the fractured layout design data for each sub-frame in that group was stored, along with the memory location or locations where the merged data is to be stored.

The distribution module 303 also provides the global parameter values for each sub-frame in the row, together with constraint values for the mask or reticle writer. As noted above, the mask or reticle writer that will use the fractured data typically will have some limitations or other features associated with it. For example, a mask or reticle writer typically will have a maximum size per input block of data. It may also restrict the input data to a maximum number of cell definitions per data block, and to a maximum total combined number of placements for all cells in an input data block. Accordingly, the writer constraint values may include a maximum data size, a maximum cell count, and a maximum cell placement count for all cell definitions.

In step 903, the merge module 307 determines the cumulative group parameter values for the group of sub-frames. For example, with the global parameter values discussed above (i.e., total size of the fractured layout design data for the sub-frame, total number of cells, and total combined number of placements for all of the cells), the merge module 307 will add the corresponding global parameter values for each sub-frame of fractured layout design data in the group. Thus, with the previously-described example, the merge module 307 will add the total size of the fractured layout design data for each sub-frame in the group to obtain total size of the fractured layout design data for the whole group. Similarly, the merge module 307 will add the total number of cells for each sub-frame of fractured layout design data to obtain the total number of different cells occurring in the fractured layout design data for the entire group. The merge module 307 also will add the total combined number of placements for all cells for the fractured layout design data in each sub-frame, to obtain the total combined number of placements for all cells in the fractured layout design data for the entire group.

Next, in step 905, the merge module 307 determines if the fractured layout design data for the entire row can be merged into a single data block, or if it must be split among two or more data blocks. More particularly, the merge module 307 compares each of the cumulative group parameter value with its corresponding constraint value. If a cumulative group parameter value exceeds its corresponding constraint value, then the merge module 307 determines that the fractured layout design data for the group cannot be merged together into a single data block, but must instead be split among two or more separate data blocks.

Thus, with the above-described example, the merge module 307 will compare the total size of the fractured layout design data for the whole group with the constraint maximum data size. The comparison may be, for example, based upon binary data size values, the size of the data measured in bytes, or both. If the total size of the fractured layout design data for the whole group exceeds the constraint maximum data size, then the merge module 307 will determine that the fractured layout design data for the group must be merged into two or more separate data blocks. Similarly, the merge module 307 will compare the total number of different cells occurring in the fractured layout design data for the entire group with the maximum cell count constraint. If the total number of different cells occurring in the fractured layout design data for the entire group exceeds the maximum cell count constraint, then the merge module 307 will determine that the fractured layout design data for the group must be merged into two or more separate data blocks. Still further, the merge module 307 will compare the total combined number of placements of all cells in the group with the maximum cell count constraint. Again, if the total combined number of placements of all cells in the group of sub-frames exceeds the maximum cell count constraint, then the merge module 307 will determine that the fractured layout design data for the group must be merged into two or more separate data blocks.

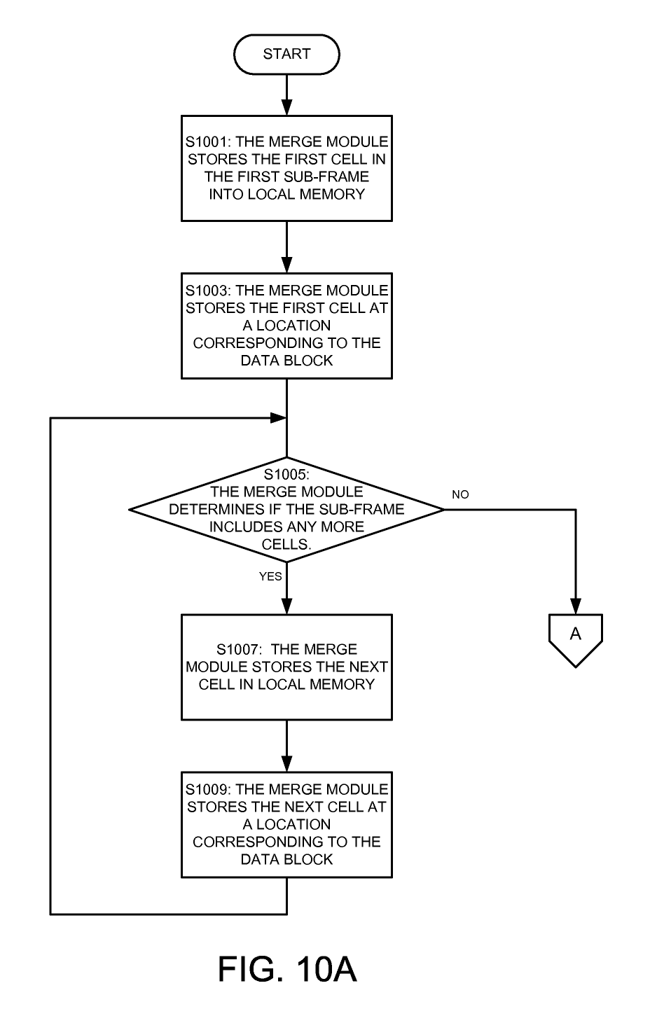

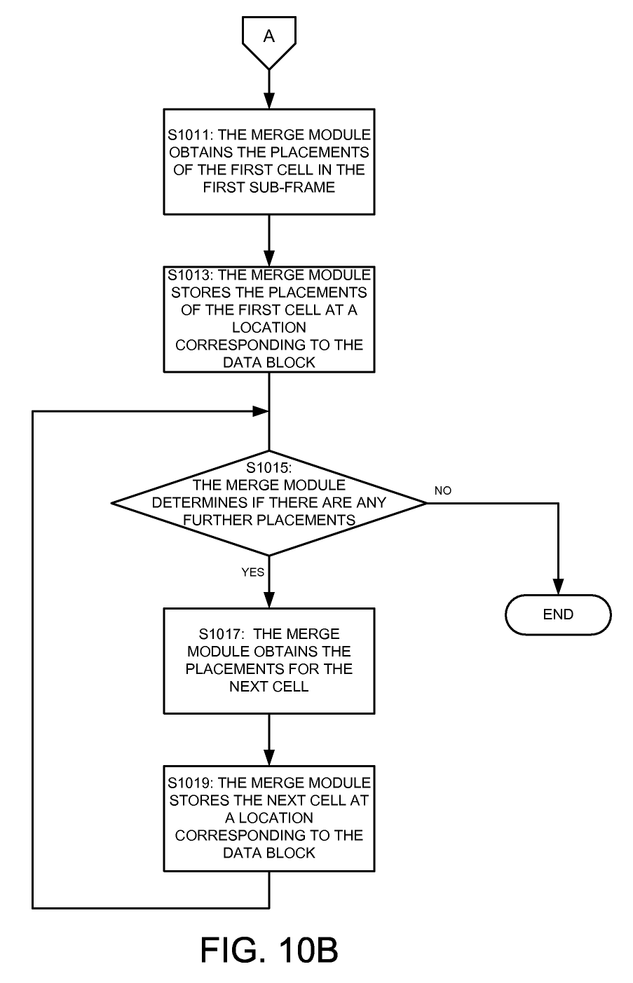

If the merge module 307 determines that the fractured layout design data can be merged into a single data block, then the merge module 307 merges the fractured layout design data for each sub-frame of the group into a single data block in step 907. This process will be discussed in more detail with respect to the flowchart shown in FIG. 10. Initially, in step 1001, the merge module 307 stores the first cell in the first sub-frame of fractured layout design data of the group into its local memory. More particularly, the merge module 307 obtains the definition describing the first cell in the first sub-frame from the location in the memory storage 309 provided by the distribution module 303. It then saves that cell definition in its local memory. Next, in step 1003, the merge module 307 saves the first cell in the memory storage 309 at a location corresponding to the data block into which the fractured layout design data is to be merged. That is, the memory storage 309 saves the cell definition for the first cell at the location in the memory storage 309 previously specified by the distribution module 303 as corresponding to the data block. In step 1005, the merge module 307 determines if the sub-frame includes any more cells. If there are, then in step 1007 the merge module 307 stores the next cell in its local memory, and, in step 1009, saves the next cell into the memory storage 309 at a location corresponding to the data block in which the fractured layout design data is to be merged.

With various examples of the invention, the merge module 307 may store the next cell in its local memory by replacing at least a portion of the cell previously saved in the local memory. For example, the merge module 307 may save the next cell definition to the local memory by simply overwriting the previously-saved cell definition. Alternately, the merge module 307 may delete the definition of the previously-saved cell from the local memory before storing the definition of the next cell in the sub-frame into the local memory. It should be noted that, because the merge module 307 can retrieve and save the definition of only one cell at time into the local memory, so as to replace the previously saved cell definition, the merge module 307 requires only a relatively small amount of local memory. That is, the merge module 307 requires only enough local memory to process the largest cell definition in the sub-frame.

As previously noted, various embodiments of the invention allow a user to designate the size of a sub-frame 601. Accordingly, with some implementations of the invention, the sub-frames 601 may be sized so that the merge module 307 can read all of the cell definitions in an entire sub-frame into local memory at one time. With these implementations, the maximum amount of local memory used will occur for the sub-frame with the maximum amount of cell definition data for a given group of sub-frames. Depending upon the sub-frame size designated by a user, the local memory consumption for this implementation may typically not exceed 2 GB-4 GB. Further, this implementation may be more efficient for disk I/O (read/write) operations. Of course, with various embodiments of the invention the merge module 307 may alternately process units of data in an intermediate size (i.e., larger than a single cell but smaller than all of the cells in a sub-frame) as desired.

It also should be appreciated that, for some reticle or mask writers, a cell's physical dimension (width and height) can be user settable. Accordingly, with some implementations of the invention, a user may alternately or additionally select the size of the largest cell definition to facilitate the ability of the merge modules 307 to process one or more of the cells using their available local memory.

Returning now to FIGS. 10A and 10B, steps 1005-1009 then are repeated until the definition of every cell in the sub-frame of fractured layout design data has been saved at the appropriate location in the memory storage 309. When the definition of every cell in the sub-frame of the group has been saved at the appropriate location in the memory storage 309, then in step 1011, the merge module 307 obtains the placements of the first cell in the first sub-frame from the location in the memory storage 309 provided by the distribution module 303. In step 1013, it then saves those cell placements in the memory storage 309 at a location corresponding to the data block into which the fractured layout design data is to be merged. That is, the memory storage 309 saves the cell placements for the first cell at the location in the memory storage 309 previously specified by the distribution module 303.

In step 1015, the merge module 307 determines if the sub-frame includes placements for any more cells. If it does, then in step 1017 the merge module 307 obtains the placements for the next cell from the memory storage 309. In step 1019, the merge module 307 saves the placements for the next cell into the memory storage 309 at a location corresponding to the data block in which the fractured layout design data is to be merged. Steps 1015-919 are repeated until the placements for every cell in the sub-frame also are stored in the memory storage 309 at the location corresponding to the data block into which all of the sub-frames in the group are to be merged.

It should be appreciated that, with alternate examples of the invention, the cell placements can be stored in the local memory of the merge module 307 until all of the cell placements have been read. The cell placements can then be sorted (e.g., for a Cartesian coordinate system, in order based upon either their x-axis coordinate values or their y-axis coordinate values), and then saved to the memory storage 309 at the location corresponding to the data block into which all the sub-frames in the frame are to be merged. This implementation typically will not require a large amount of memory, because a cell placement usually can be described by a few integers, each of which can be expressed using either 4 bytes or 9 bytes. For example, a cell placement can be defined by three characteristics: an x-axis coordinate, a y-axis coordinate, and an offset to a cell definition in the storage 309. A typical integrated circuit design may have 200,000 to 1 million cell placements in a conventional frame, which would correspond to (4+4+4) bytes per cell placement, or 2.4 MB to 12 MB for all of the cell placements in a conventional frame.

The process of steps 1001-1019 are repeated for each sub-frame in the group, until every cell in the group, as well as its placements, are saved in the memory storage 309 at the location specified by the distribution module 303. Once the cells and their placements have been saved, this data block created at the specified memory location is in a form that can be provided to the mask or reticle writing tool. Moreover, because the cumulative parameter values for the group have been compared with the constraint values for the mask or reticle writing tool, a user can be assured that the data block can be appropriately handled by the mask or reticle writing tool. As also noted above, because the merge module 307 can retrieve and save the definition of only one cell at time into the local memory while replacing the previously-saved cell definition, it requires only enough local memory to process the largest cell definition in the sub-frame.

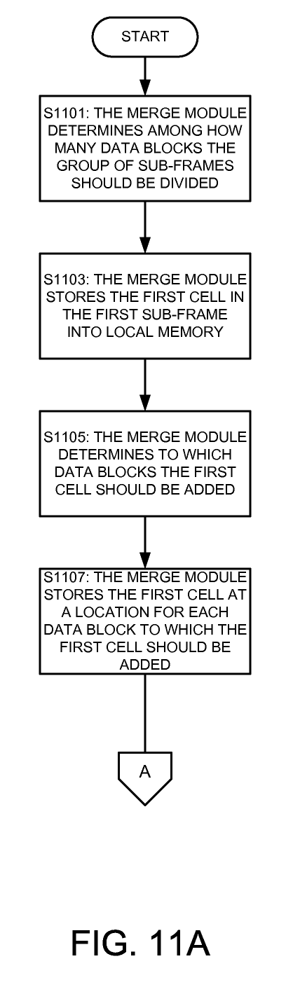

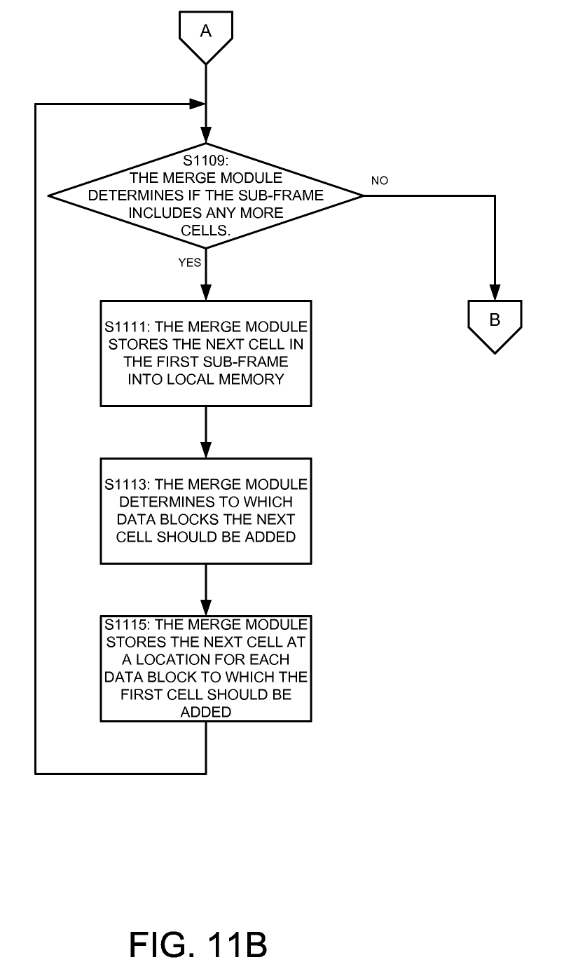

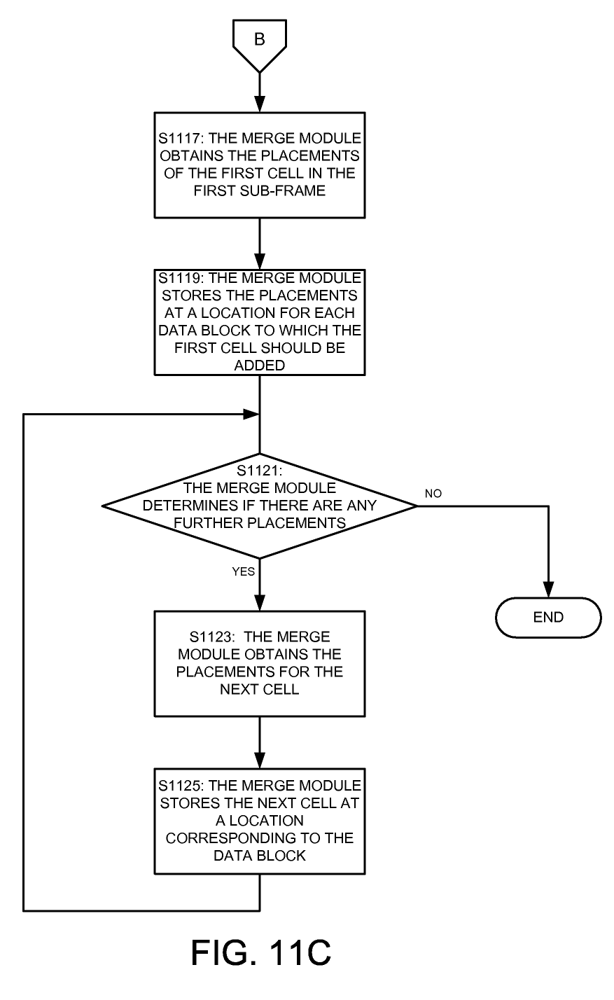

Returning now to FIG. 9, if the merge module 307 determines in step 905 that the fractured layout design data for the group should be merged or assimilated into multiple data blocks, then, in step 909 the merge module 307 merges the fractured layout design data for each sub-frame into multiple data blocks. This process will be discussed in detail below with respect to the flowchart shown in FIGS. 11A-11C.

Initially, in step 1101, the merge module 307 determines the number of separate data blocks into which the group of sub-frames will be merged. With some implementations of the invention, the merge module 307 may simply divide the layout data in the group of sub-frames 601 among two separate data blocks. While this technique is relatively simple to implement, it may be unsuitable for layout designs with relatively dense areas of geometrical elements. Further, as newer technologies allow designers to increase the density of geometrical elements in a design, this simple division technique may become unsuitable for an increasing number of layout designs. To provide better accuracy in dividing layout design data among separate data blocks, various examples of the invention may partition each sub-frame into sections, and then determine global parameter values for each section of each sub-frame in the group as noted above. The merge module 307 can then use these sectional global parameter values to determine how the layout design data in the sub-frames of a group should be merged into two or more data blocks.

For example, referring back to FIG. 7, various implementations of the invention will determine the group values of the global parameters for the combination of the sections 701A and 701B (i.e., P{SECTION 701A+SECTION 701B} and the group global parameter values for the combination of the sections 701C and 701D (i.e., {SECTION 701C+SECTION 701D}. That is, the merge module 307 can sum the respective global parameter values for the combination of the sections 701A and 701B in each sub-frame of the group, to determine a group value of each global parameter for those sections. Similarly, the merge module 307 can sum the respective global parameter values for the combination of the sections 701C and 701D in each sub-frame of the group, to determine a group value of each global parameter for the combination of those sections. If none of the group global parameter values for the combinations of those sections exceeds the constraint values, then the merge module 307 will determine that the layout design data for the group of sub-frames need only be split among two separate data blocks. More particularly, the merge module 307 will determine that the layout design data in sections 701A and 701B of each sub-frame can be written to a first memory location corresponding to a first data block, and that the layout design data in sections 701C and 701D of each sub-frame can be written to a second memory location corresponding to a second data block.

If, however, the merge module 307 determines that any of the group global parameter values for the combination of the sections 701A and 701B exceeds a corresponding constraint value, then the merge module 307 will determine that the layout design data in sections 701A and 701B for each sub-frame must be divided among two separate data blocks. Similarly, if the merge module 307 determines that any of the group global parameter values for the combination of the sections 701C and 701D exceeds a corresponding constraint value, then the merge module 307 will determine that the layout design data in sections 701C and 701D for each sub-frame must be divided among at least two separate data blocks.

For example, if the merge module 307 determines that sum of the total data size for the combination of the sections 701A and 701B in the sub-frames of the group exceeds the allowable size of an input data block for the reticle or mask writer, then the merge module 307 will determine that the layout design data in the sections 701A and 701B in the sub-frames of the group must be divided among at least two separate data blocks. Likewise, the merge module 307 may determine that the total number of cell definitions in the sections 701C and 701D in the sub-frames of the group exceeds the maximum allowable number of cell definitions that may be input to the reticle or mask writer. If it does, then the merge module 307 will determine that the layout design data in the sections 701C and 701D in the sub-frames of the group must be divided among at least two separate data blocks.

If the merge module 307 determines that the layout design data in a combination of sections in the sub-frames of the group must be divided among separate data blocks, then it determines whether the layout design data for each section of that combination must be divided among separate data blocks. For example, if the merge module 307 determines that the layout design data in the sections 701C and 701D of the sub-frames of the group must be divided among at least two separate data blocks, then it will sum the corresponding values of the global parameters for each section 701C (i.e., P{SECTION 701C}) in all of the sub-frames of the group to obtain the group global parameter values for the sections 701C. The merge module 307 also will sum the corresponding global parameter values for each section 701D (i.e., P{SECTION 701D}) in all of the sub-frames of the group to obtain the group global parameter values for the sections 701D. If any of the group global parameter values for the sections 701C exceeds a corresponding constraint value, then the merge module 307 will divide the layout design data for the sub-frame sections 701C of the row among two separate data blocks. Likewise, if any of the group global parameter values for the sections 701D exceeds a corresponding constraint value, then the merge module 307 will divide the layout design data for the sub-frame sections 701D of the row among two separate data blocks.

In this manner, by employing the group global parameter values determined for each sub-frame section and combination of sub-frame sections of the group, the merge module 307 can determine among how many different data blocks the layout design data must be divided. Further, the merge module 307 can determine into which data block each cell of fractured layout data should be sorted. For example, it will be apparent from the foregoing explanation that the merge module 307 can determine that the layout design data in the sub-frame sections 701A of a group will be directed to one data block, while the layout design data in the sub-frame sections 701B of that group will be directed to a second data block. Further, the merge module 307 can determine that the layout design data in both the sub-frame sections 701C and the sub-frame sections 701D of a group will all be directed to single, third data block. Alternately, the merge module 307 can determine that the layout design data in both the sub-frame sections 701A and the sub-frame sections 701B of a group will all be directed to single, first data block. It can then determine that the layout design data in the sub-frame sections 701C of that group will be directed to a second data block, while the layout design data in the sub-frame sections 701D of that group will be directed to a third data block.

As previously noted, some implementations of the invention may only determine global parameter values for each sub-frame section, and omit determining global parameter values for combinations of sub-frame sections. With these embodiments, the merge module 307 can sum the global parameter values for two or more sub-frame sections, to approximate the global parameter value for the combination of those sub-frame sections. For example, the merge module 307 can add the global parameter values for the section 701A in a sub-frame to the corresponding global parameter values for the section 701B in the sub-frame. This sum would provide an approximation of the global parameter values that would be determined for the combination of the sub-frame section 701A and the sub-frame section 701B. The merge module 307 could then use these approximate global parameter values to determine if and how the layout design data in the sub-frames of a group should be divided among separate data blocks, as discussed in detail above.

It should be noted that, with these implementations of the invention, the merge module 307 may over-count of one or more of the global parameter values in creating an approximation. For example, if a cell A is defined and placed in both section 701A and section 701B of a sub-frame, then its occurrence would contribute a count to the total combined number of cell definitions for both the sub-frame section 701 and the sub-frame section 701B. Accordingly, summing these parameter values to approximate the corresponding global parameter value for the combination of sub-frame sections 701A and 701B would overcount the presence of the cell definition A by one. It will be appreciated, however, that the approximate will not undercount a global parameter value. Accordingly, while this technique is less accurate than the technique described in detail above and may unnecessarily divide a row of sub-frames among two data blocks, it is simpler and will not fail to divide a row of sub-frames when necessary to comply with the constraints of a reticle or mask writer.

Further, it should be appreciated that this technique may omit the need to determine the global parameter values for each entire sub-frame. Instead, the global parameter values for each sub-frame may be approximated by adding the corresponding global parameter values for each section in the sub-frame. Again, while this technique would be less accurate than determining the global parameter values for the entire sub-frame as described in detail above, it is simpler and will not fail to divide a row of sub-frames when necessary to comply with the constraints of a reticle or mask writer.

If the merge module 307 determines that a group of sub-frames will need to be divided among two or more separate data blocks, then it may save the separate data blocks into two temporary files according to a previously-determined file naming convention. Alternately, the merge module 307 may submit a request to the distribution module 305 for additional memory locations associated with each of the required additional data blocks, and, with some examples of the invention, provide information on the temporary files to the distribution module 305. For example, the merge module 307 can send the following information back to the distribution module 305: {number of new data blocks created, and file name under which the fractured data for each newly created data block}. If the group of sub-frames has not been divided, then the value of the number of the number of new data blocks may be “1.” If the group of sub-frames has not been divided into two new data blocks, then the value of the number of the number of new data blocks may be “2.” In this case, the file names for the two new data block files can be sent back to the distribution module 303, or named according to a predetermined naming rule. At the conclusion of the merging step for all of the sub-frames in the group, the distribution module 305 can re-sort the data block files and rename them accordingly if group splitting has occurred.

While an example of a sub-frame partitioned into four sections 701A-701D has been described in detail above, it should further be appreciated that various implementations of the invention may divide the sub-frames into any number of sections. It also should be appreciated that, rather than partition a single sub-frame into multiple sections as described above, various examples of the invention may alternately or additionally designate sub-frames of smaller heights. For example, rather than partition each sub-frame into four sections, some implementations may designate the height of each sub-frame so that four rows of sub-frames will correspond to a single conventional frame. With these embodiments of the invention, all four rows of sub-frames may be merged into a single block of data, or divided among two or more separate blocks of data using the techniques described for the sub-frame sections above.

Returning now to FIGS. 11A-11C, once the merge module 307 has determined the number of blocks of data into which the group of sub-frames will be merged, in step 1103 it stores the first cell in the first sub-frame of fractured layout design data for its assigned group into its local memory. That is, the merge module 307 obtains the definition describing the first cell in the first sub-frame from the location in the memory storage 309 provided by the distribution module 303. It then saves that cell definition in its local memory. Next, in step 1105, the merge module 307 employs the cell occurrence information discussed in detail above to determines into which data blocks the cell should be saved, and saves the first cell in the memory storage 309 at a location corresponding to each of the data blocks into which the fractured layout design data is to be merged in step 1107. For example, if the cell definition for the first cell is to be merged into two separate data blocks, the merge module 307 saves the cell definition for the first cell at the location in the memory storage 309 specified for the first data block. It also saves another copy of the cell definition for the first cell at a different location in the memory storage 309 specified for the second data block. In step 1109, the merge module 307 determines if the sub-frame includes any more cells. If there are any remaining cells, then in step 1111 the merge module 307 stores the next cell in its local memory.

As previously note, various examples of the merge module 307 may store the next cell in its local memory by replacing at least a portion of the cell previously saved in the local memory. For example, the merge module 307 may save the next cell definition to the local memory by simply overwriting the previously-saved cell definition, or it may delete the definition of the previously-saved cell from the local memory before storing the definition of the next cell in the sub-frame into the local memory. Because the merge module 307 can retrieve and save the definition of only one cell at time into the local memory, so as to replace the previously saved cell definition, the merge module 307 requires only a relatively small amount of local memory. That is, the merge module 307 requires only enough local memory to process the largest cell definition in the sub-frame.

Various embodiments of the invention alternately may employ sub-frames 601 that have been sized so that the merge module 307 can read all of the cell definitions in an entire sub-frame into local memory at one time, as also discussed in detail above. With these implementations, the maximum amount of local memory used will occur for the sub-frame with the maximum amount of cell definition data for a given group of sub-frames. Again, with some implementations of the invention, a user may alternately or additionally select the size of the largest cell definition to facilitate the ability of the merge modules 307 to process one or more of the cells using their available local memory.

In step 1113, the merge module 307 determines into which data blocks the cell should be saved. Then, in step 1115, the merge module 307 saves the first cell in the memory storage 309 at a location corresponding to each of the data blocks into which the fractured layout design data is to be merged. Thus, as previously noted, if the cell definition for the next cell is to be merged into two separate data blocks, the merge module 307 saves the cell definition for the cell at both the location in the memory storage 309 specified for the first data block, and at a different location in the memory storage 309 specified for the second data block.

Again, because the merge module 307 retrieves and saves the definition of only one cell at time into the local memory so as to replace the previously saved cell definition, it should be noted that, the merge module 307 requires only a relatively small amount of local memory. That is, the merge module 307 requires only enough local memory to process the largest cell definition in the sub-frame.

Steps 1109-1115 then are repeated until the definition of every cell in the sub-frame of fractured layout design data has been saved at the appropriate location or locations in the memory storage 309. Next, in step 1117, the merge module 307 obtains the placements of the first cell in the first sub-frame from the location in the memory storage 309 provided by the distribution module 303. In step 1119, it then saves those cell placements in the memory storage 309 at a location corresponding to each of the data blocks into which the fractured layout design data is to be merged. For example, if a cell should have placements in both a first data block and a second data block, then the memory storage 309 saves the cell placements that should occur in the first data block at the location in the memory storage 309 specified for that data block. The memory storage 309 also saves the cell placements that should occur in the second data block at another location in the memory storage 309 specified for the second data block.

In step 1121, the merge module 307 determines if the sub-frame includes placements for any more cells. If there are, then in step 1123 the merge module 307 obtains the placements for the next cell from the memory storage 309. Then, in step 1125, the merge module 307 saves the appropriate placements for the next cell into the memory storage 309 at a location corresponding to each of the data blocks in which the cell should occur. Steps 1119-1125 then are repeated until the placements for every cell in the sub-frame also are stored in the memory storage 309 at the locations corresponding to the data blocks in which their associated cells should occur.

The process of steps 1101-1125 are repeated for each sub-frame in the group, until every cell in the group, as well as its placements, are saved in the memory storage 309. Once the cells and their associated placements have been saved, the data block formed at the associated memory location can be provided to the mask or reticle writing tool. Moreover, because the appropriate cumulative group parameter values for the group have been compared with the constraint values for the mask or reticle writing tool, a user can be assured that the data block can be appropriately handled by the mask or reticle writing tool. As also noted above, because the merge module 307 can retrieve and save the definition of only one cell at time into the local memory while replacing the previously-saved cell definition, it requires only enough local memory to process the largest cell definition in the sub-frame.

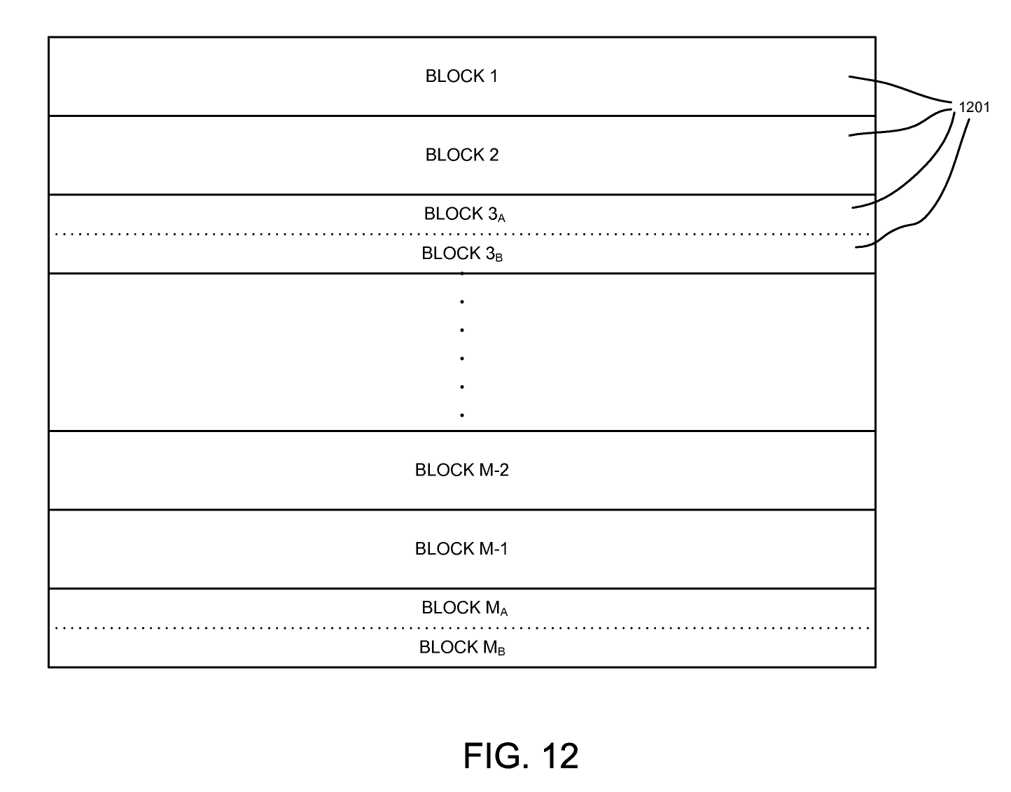

In this manner, the layout design data for each frame in the entire design is fractured, and then merged back into one or more data blocks 1201 that can be processed by the reticle or mask writer, as illustrated in FIG. 12. If the fractured layout design data for a frame meets the specified constraint requirements, then it is merged back into a single data block, such as the blocks labeled “BLOCK 1,” “BLOCK 2,” “BLOCK M−2,” and “BLOCK M−1,” which correspond to the frames in FIG. 5A labeled “FRAME 1,” “FRAME 2,” “FRAME M−2,” and “FRAME M−1,” respectively. If, however, the fractured layout design data for a frame does not meet the specified constraint requirements, then it is merged into two or more data blocks 1201. For example, as illustrated in FIG. 12, the fractured layout design data from the frame labeled “FRAME 3” in FIG. 5A has been merged into the blocks labeled “BLOCK 3_{A}” and “BLOCK 3_{B}” in FIG. 12. Similarly, the fractured layout design data from the frame labeled “FRAME M” in FIG. 5A has been merged into the blocks labeled “BLOCK MA” and “BLOCK MB” in FIG. 12

The above examples have been described with respect to reticle or masks writers that employ frames where the width of each frame spans the entire length of the layout design, as illustrated in FIG. 5A. It should be appreciated, however, that various implementations of the invention also may advantageously be employed for reticle or masks writers that employ frames where the width of each frame spans only a portion of the entire length of the layout design, as illustrated in FIG. 5B.

As seen in this figure, the layout design may be divided into, e.g., two rows and two columns, with each frame spanning only the length of its corresponding column. As will be appreciated by those of ordinary skill in the art, however, the amount of layout design data corresponding to an entire frame may still be too large for efficient distribution among different computing nodes in a parallel computing system. Still further, the amount of fractured data corresponding to an entire frame also may violate one or more constraints of the reticle or mask writer. Advantageously, various implementations of the invention may divide the layout design data into segments of any desired size for efficient distribution to different computing nodes in a parallel computing system for fracturing. Moreover, by employing the global parameters as described above, these embodiments of the invention can then merge the fractured layout design data into data blocks that can be provided to the reticle or mask writer without violating the writer's constraints.

### CONCLUSION

From the foregoing description, it will be apparent that various examples of the invention provide for the efficient distribution, processing, and merger of data, such as layout design data. Moreover, because various examples of the invention allow the data to be divided up and subsequently process in relatively small units, these examples of the invention are particularly useful in efficiently and scalably distributing data among multiple computing nodes in a parallel computing system. Also, while various examples of the invention have been described with respect to the fracturing of layout design data, it should be appreciated that one or more aspects of the invention are applicable to the distribution of a variety of types of data for a variety of processes, including processes that are unrelated to electronic design automation. For example, some implementations of the invention may operate on other units of data that cannot be categorized into cells, as described above. These implementations of the invention may instead operate on any desired units of data, including units of data that are selected arbitrarily or based upon unit size.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to particular electronic design automation processes, it should be appreciated that various examples of the invention may be implemented using any desired combination of electronic design automation processes.

What is claimed is:

1. A method of merging data into a block of data, comprising:
identifying a first cell in a first segment of data;
obtaining a definition of the first cell;
saving the definition of the first cell to a memory location corresponding to a block of data;
identifying a second cell in the first segment of data or in a second segment of data different from the first segment of data;
obtaining a definition of the second cell; and
saving the definition of the second cell to the memory location corresponding to the block of data.

2. The method recited in claim 1, wherein
obtaining the definition of the first cell includes saving the definition of the first cell in a local memory; and
obtaining the definition of the second cell includes saving the definition of the second cell to the local memory so as to replace at least a portion of the definition of the first cell.

3. The method recited in claim 2, wherein saving the definition of the second cell to the memory includes overwriting the definition of the first cell saved in the local memory.

4. The method recited in claim 2, further comprising deleting the definition of the first cell from the local memory before saving the definition of the second cell to the local memory.

5. The method recited in claim 1, further comprising:
obtaining placements of the first cell;
saving the placements of the first cell to the memory location corresponding to the block of data;
obtaining placements of the second cell; and
saving placements of the second cell to the memory location corresponding to the block of data.

6. The method recited in claim 1, further comprising
determining that the first cell also should be assimilated into a second block of data; and
saving the definition of the first cell to a second memory location corresponding to the second block of data.

7. The method recited in claim 6, further comprising
identifying placements of the first cell that should occur in the second block of data; and
saving the identified placements of the first cell to the memory location corresponding to the second block of data.

8. The method recited in claim 1, further comprising
identifying a third cell in the first segment of data;
obtaining a definition of the third cell;
determining that the third cell should be assimilated into a second block of data; and
saving the definition of the third cell to a second memory location corresponding to the second block of data.

9. The method recited in claim 8, further comprising:
identifying placements of the third cell that should occur in the second block of data; and
saving the identified placements of the third cell to the memory location corresponding to the second block of data.

10. The method recited in claim 1, wherein the data in the first data segment and the second data segment is fracture data for a mask writer.

11. A method of assimilating data into blocks, comprising:
identifying a plurality of data segments associated with a frame of data, each data segment including at least one cell and a global parameter value;
summing the global parameter value for each data segment to produce a cumulative frame parameter value;
comparing the cumulative frame parameter value with a data block constraint value; and
if the cumulative frame parameter value exceeds the data block constraint value, assimilating the data segments into at least two data blocks.

12. The method recited in claim 11, wherein
the global parameter is a total size of the data segment and the data block constraint is a maximum data block size; or
the global parameter is a number of cells in the data segment and the data block constraint is a maximum number of cells for a data block; or
the global parameter is a number of placements of cells in the data segment and the data block constraint is a maximum number of placements of cells for a data block.

13. The method recited in claim 11, wherein
each data segment includes a second global parameter value; and
further comprising
summing the second global parameter values for each data segment to produce a second cumulative frame parameter value;
comparing the second cumulative frame parameter value with a second data block constraint value; and
if the second cumulative frame parameter value exceeds the second data block constraint value, assimilating the data segments into at least two data blocks.

14. The method recited in claim 13, wherein
the second global parameter is a total size of the data segment and the second data block constraint is a maximum data block size; or
the second global parameter is a number of cells in the data segment and the second data block constraint is a maximum number of cells for a data block; or
the second global parameter is a number of placements of cells in the data segment and the second data block constraint is a maximum number of placements of cells for a data block.

15. The method recited in claim 13, wherein
each data segment includes a third global parameter value; and
further comprising
summing the third global parameter values for each data segment to produce a third cumulative frame parameter value;
comparing the third cumulative frame parameter value with a third data block constraint value; and
if the third cumulative frame parameter value exceeds the third data block constraint value, assimilating the data segments into at least two data blocks.

16. The method recited in claim 15, wherein
the third global parameter is a total size of the data segment and the third data block constraint is a maximum data block size; or
the third global parameter is a number of cells in the data segment and the third data block constraint is a maximum number of cells for a data block; or
the third global parameter is a number of placements of cells in the data segment and the third data block constraint is a maximum number of placements of cells for a data block.

17. The method recited in claim 11, further comprising, for each data segment:
identifying each cell in the data segment; and
for each cell,
determining each data block in which the cell should occur, and
for each data block in which the cell should occur, saving a definition of the cell in a memory location associated with the data block.

18. The method recited in claim 17, further comprising, for each cell, saving a definition of the cell in a local memory such that, if a definition of a cell was previously saved in the local memory, saving the definition of the cell replaces at least a portion of the definition of the previously saved cell.

19. The method recited in claim 18, wherein saving the definition of the cell in the local memory includes overwriting the definition of the previously saved cell.

20. The method recited in claim 18, further comprising deleting the definition of the previously saved cell from the local memory before saving the definition of the cell to the local memory.
